(19) United States
(12) Patent Application Publication
(10) Pub. No.: US 2015/0034515 A1
(43) Pub. Date: Feb. 5, 2015

(54) Underground Mining Tool Packaging with Increased Visibility Feature

(71) Applicant: Sandvik Intellectual Property AB, Sandviken (SE)

(72) Inventors: Kenneth Monyak, Abingdon, VA (US); Tadeusz Kozminski, Valencia, PA (US)

(73) Assignee: Sandvik Intellectual Property AB, Sandviken (SE)

(21) Appl. No.: 13/958,925

(22) Filed: Aug. 5, 2013

(51) Int. Cl. B25H 3/02; E21C 35/183

(52) U.S. Cl. CPC B25H 3/02; E21C 35/183
USPC 206/349; 206/457; 299/105

(57) ABSTRACT

Container for tools for excavating and cutting geological formations has a base structure with an interior volume accessible via an opening and a lid connected to the base structure to close the opening. A visibility enhancing feature is incorporated into one or more of the lid and the base structure, the visibility enhancing feature based on luminescence or reflectance. A kit including the container and methods of illuminating a portion of an underground mine and of identifying a tool located in an underground mine are also disclosed. When placed in an underground mine and irradiated or illuminated, visible electromagnetic radiation associated with the visibility enhancing feature can illuminate a structure of the underground mine, illuminate a content of the container and/or be an indicia of the tool stored in the container.

### FIELD OF THE DISCLOSURE

The present disclosure relates to a container for tools for excavating and cutting geological formations. More specifically, the present disclosure relates to a container, such as a storage container or packaging for underground mining tools, a portion of which incorporates an increased visibility feature. The increased visibility feature includes one or more of a phosphor material incorporated into a portion of the container and a reflective material incorporated into a portion of the container. Luminescence from the portion of the container incorporating the phosphor material illuminates the content of the box and/or the environmental surroundings and can be indicia of contents or other identifying information; light reflected by the reflective material incorporated into a portion of the container provides ease of locating and/or can be indicia of contents or other identifying information.

### BACKGROUND

In the discussion that follows, reference is made to certain structures and/or methods. However, the following references should not be construed as an admission that these structures and/or methods constitute prior art. Applicants expressly reserve the right to demonstrate that such structures and/or methods do not qualify as prior art against the present invention.

In underground and other areas not accessible by natural light, the failure of artificial light, if any, can result in near total black-out conditions. Although not planned, the failure of artificial light in such areas can result in adverse safety conditions. Further, even when artificial light is present, operating conditions can reduce visibility, which also adversely impacts safety conditions as well as operating efficiency for tasks requiring operators to visibly identify and/or manipulate objects.

Other safety and operating concerns in underground and other areas not accessible by natural light is the locating and identification of replaceable parts for the operating equipment. Replaceable parts such as tool picks for underground mining machines need frequently replacement as the cutting and excavating of geological formations wears down such parts. However, keeping spare parts local to the operating site can impact safety, as the containers for such parts are easily not noticed by operating personnel, particularly after such containers become dirty from mine operations. Further, content specific identification labels can become unreadable, either from dirt, from wear of the label, or otherwise, which slows the process of locating appropriate replaceable parts for the operating equipment.

### SUMMARY

A container for underground mining tools has a portion which incorporates an increased visibility feature. The increased visibility feature includes one or more of a phosphor material incorporated into a portion of the container and a reflective material incorporated into a portion of the container.

In one aspect, the increased visibility feature is a phosphor material. Luminescence from the portion of the container incorporating the phosphor material illuminates the content of the box and/or the environmental surroundings and can be indicia of contents or other identifying information. In addition, light reflected by the reflective material incorporated into a portion of the container provides ease of locating.

In another aspect, the increased visibility feature is a reflective material incorporated into or affixed to a portion of the container. Light reflected from the portion of the container incorporating the reflective material or to which the reflective material is affixed provides an indicia of contents or other identifying information and ease of locating.

An exemplary embodiment of a container for tools for excavating and cutting geological formations comprises a base structure including a bottom and one or more side walls joined to define an interior volume accessible via an opening, a lid connected to the base structure to close the opening, the lid including a first surface and a second surface, wherein when the lid closes the opening, the first surface faces the interior volume and the second surface forms a part of an exterior of the container, and a visibility enhancing feature incorporated into one or more of the lid and the base structure, the visibility enhancing feature based on luminescence or reflectance.

Exemplary embodiments of a container for tools for excavating and cutting geological formations can be included in a kit, which also comprises a tool for excavating and cutting geological formations, wherein the tool is a cutting pick and includes an axially rearward shank portion and an axially forward head portion, the head portion further including a shoulder portion and a cutting tip.

Another exemplary embodiment of a container for tools for excavating and cutting geological formations comprises a base structure including a bottom and one or more side walls joined to define an interior volume accessible via an opening, and a lid connected to the base structure to close the opening, the lid including a first surface facing the interior volume and a second surface opposing the first surface and forming a part of an exterior of the container, wherein the base structure is formed of a first thermoplastic composition comprising at least one thermoplastic resin and a first phosphor, the first phosphor homogenously distributed in the first thermoplastic composition, wherein the lid is formed from a second thermoplastic composition comprising at least one thermoplastic resin and a second phosphor, the second phosphor homogenously distributed in the second thermoplastic composition, wherein visible electromagnetic radiation emitted by the first phosphor of the first thermoplastic composition is observable from interior surfaces of the base structure and from exterior surfaces of the base structure, and wherein visible electromagnetic radiation emitted by the second phosphor of the second thermoplastic composition is observable from the first surface of the lid and from the second surface of the lid.

Exemplary methods of illuminating a portion of an underground mine comprises irradiating with electromagnetic radiation or particle radiation exemplary embodiments of a container for tools for excavating and cutting geological formations, wherein the visibility enhancing feature of the container is based on luminescence from a first thermoplastic composition comprising at least one thermoplastic resin and a first phosphor, and wherein one or more of the lid and a portion of the base structure are formed from the first thermoplastic composition, and placing the container in a location in an underground mine, wherein the visible electromagnetic radiation emitted by the phosphor of the thermoplastic composition illuminates a structure of the underground mine. In further exemplary methods, a color of the visible electromagnetic radiation emitted by the phosphor of the thermoplastic composition is an indicia of the tool stored in the container.

### BRIEF DESCRIPTION OF THE DRAWING

The following detailed description of preferred embodiments can be read in connection with the accompanying drawings in which like numerals designate like elements and in which:

FIGS. 1 and 2A and 2B show perspective views of an exemplary embodiment of a container for tools for excavating and cutting geological formations in an open (FIG. 1) and closed (FIGS. 2A and 2B) configuration.

FIG. 3A shows another perspective view of an exemplary embodiment of a container for tools for excavating and cutting geological formations and FIG. 3B shows a end-on cross sectional view of the container in FIG. 3A as seen along a cross section taken at (I-I) and showing some features of the interior volume of the container.

FIG. 4 shows in cut-away, disassembled view, an example of a tool supported in a container by the integrated support structures.

FIG. 5 shows a basic sequence of irradiating a container, emitting visible light from the container and the subsequent (i) illumination of the mine and/or (ii) correlation to a particular contents or use of the container.

FIG. 6 showing a perspective view of an exemplary embodiment of a container for tools for excavating and cutting geological formations with an example of a reflectance structure in the form of a coating or a layer on its surfaces.

### DETAILED DESCRIPTION

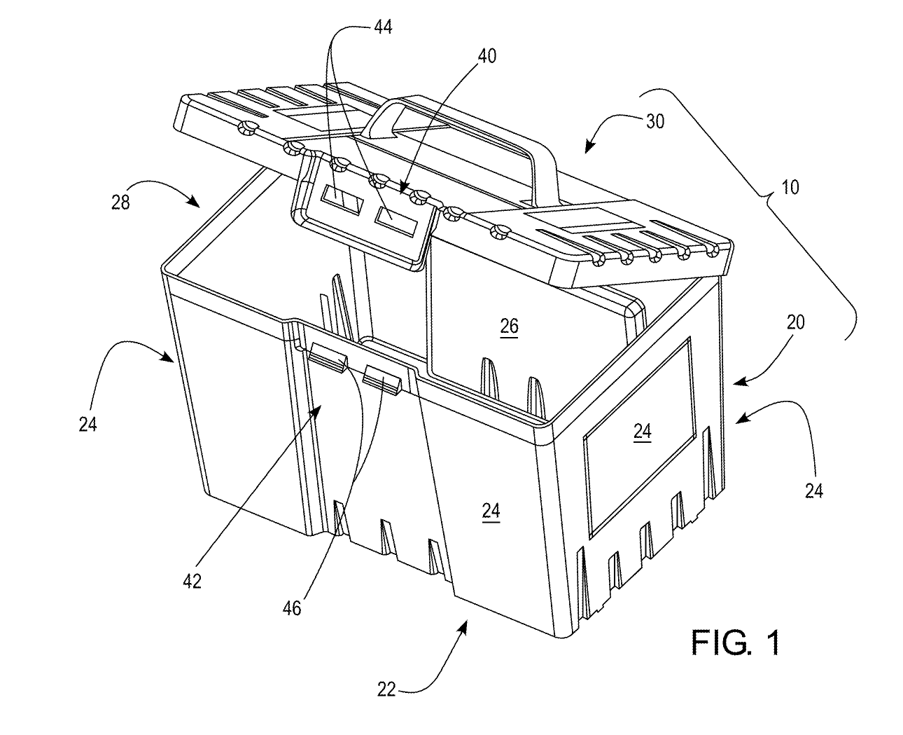

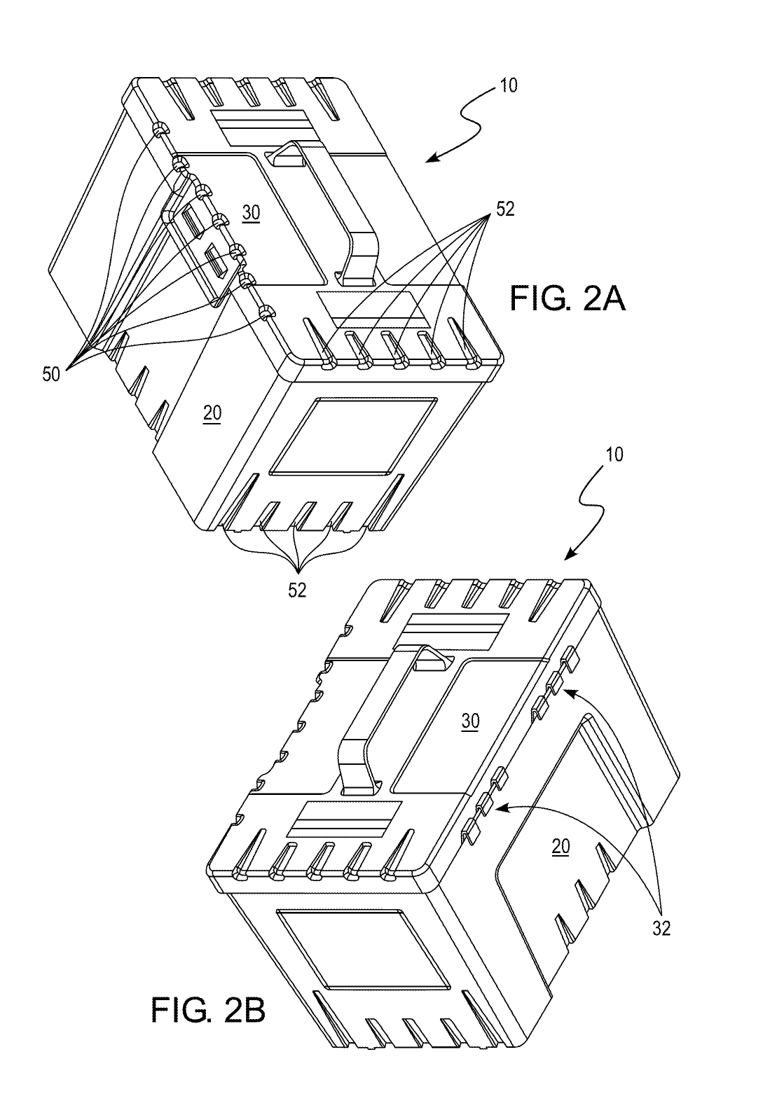

FIG. 1 shows an exemplary embodiment of a container for tools for excavating and cutting geological formations. The container 10 comprises a base structure 20. The base structure 20 includes a bottom 22 and one or more side walls 24 joined to define an interior volume 26 accessible via an opening 28. In an exemplary embodiment, the bottom and one or more side walls form five sides of a box. A lid 30 is connected to the base structure 20 via a hinge 32 to close the opening 28. The lid 30 includes a first surface 34 and a second surface 36. When the lid 30 closes the opening 28, as seen in FIGS. 2A and 2B, the first surface 34 faces the interior volume 26 and the second surface 36 forms a part of an exterior of the container 10.

The container 10 includes a latch 40 for securing the lid 30 in a closed position. The latch 40 can be any suitable structure that releasable secures the lid 30 to the base structure 10. In exemplary embodiments, the latch 40 is integrally formed with the lid 30 and, when the lid 30 pivots on the hinge 32 located on a first edge, the latch 40 on a second edge of the lid 30 snaps onto a receiver 42 on one of the side walls 24. To disengage the latch 40 from the receiver 42, the latch 40 is bendable to lift openings 44 in the latch 40 off of and away from cooperating protrusions 46 on the receiver 42. Together, the latch 40 and receiver 42 shown in FIGS. 1 and 2A-2B are also known as a flex tab connector.

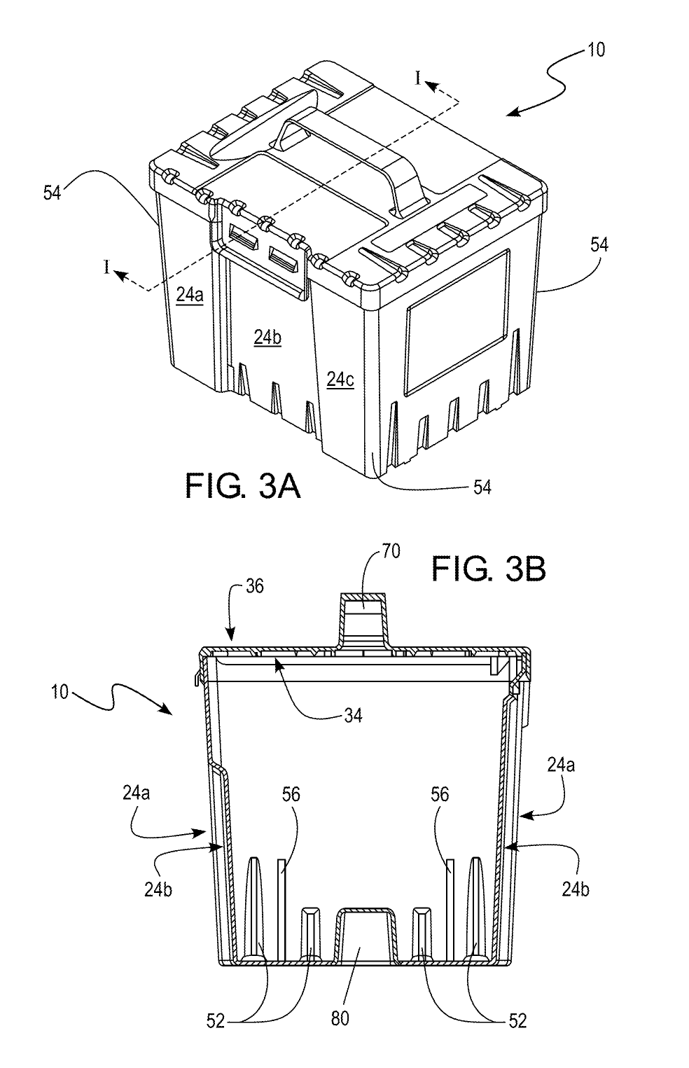

Both the base structure 20 and the lid 30 can include features that reinforce the strength of the container, and indirectly increase the weight of objects that can be placed in and carried in the container. In one example of such a reinforcing feature, edges of the base structure 20 and the lid 30 can include indentations 50, ribs 52 or combinations thereof. Both indentations 50 and ribs 52 are structures on the exterior surface of the base structure 20 and the lid 30, but ribs 52 have a major length of the indented surfaces running along one of the exterior surfaces that meet at the edge while indentations are shaped more symmetrically with respect to the amount of penetration the indented surfaces make on each of the surfaces that meet at the edge. As another example of such a reinforcing feature, one of more side walls 24 of the base structure 20, preferably at least one pair of opposing side walls, has a surface that is more than a single planar surface. In other words, the side wall 24 includes connected planar surfaces with at least a portion of a central planar surface 24b connected to and offset (when viewed in cross section) from two edge planar surfaces 24a, 24c. The two edge planar surfaces 24a, 24c are generally towards the corners 54 formed with the adjacent side wall and that, when joined together, form the side of a box defined by the side walls 24 and the bottom 22. Such an arrangement is shown in FIG. 3A, with a cross section (I-I) in FIG. 3B. In the exemplary embodiment shown in FIGS. 3A and 3B, the central planar region 24b is offset inwardly from and parallel to the two edge planar surfaces 24a, 24c on the associated side wall 24. As a further example of such a reinforcing feature, interior surfaces of the side walls 24 can have one or more solid pieces of extruded material, or gussets 56, generally formed of the same material as forms the side walls and coextruded therewith.

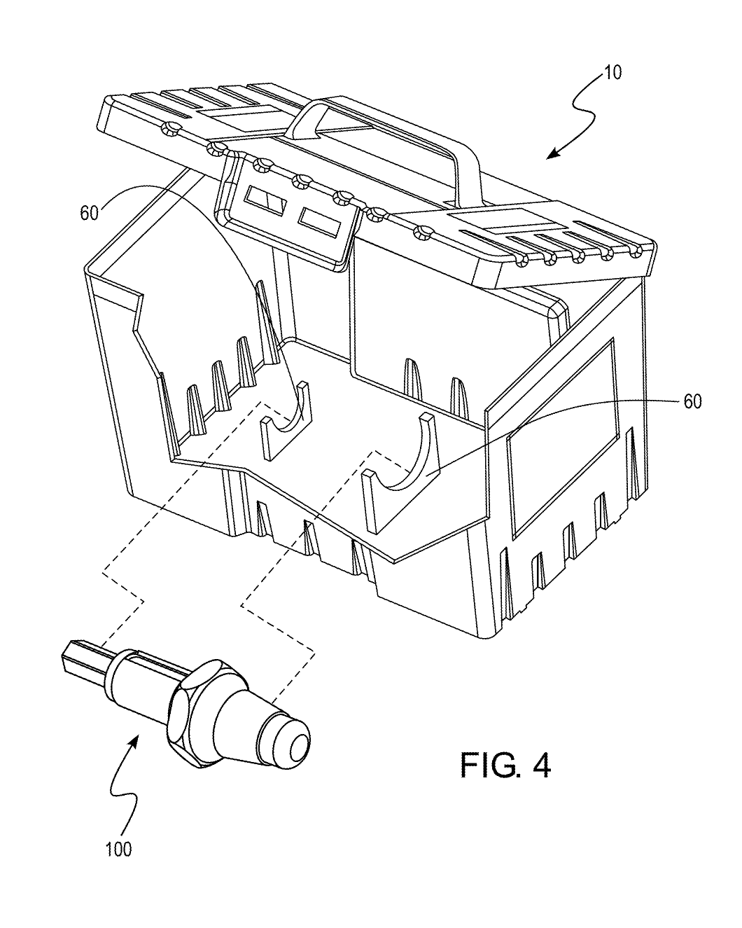

In addition to reinforcing features, the interior of the container 10 can include one or more support structures 60 for a tool to be stored and carried in the container 10. The tool can be any tool suitable for use for excavating and cutting geological formations, and preferably is a conical or radial tool pick or associated holder block, such as those disclosed in U.S. Pat. No. 8,007,048, U.S. Pat. No. 8,007,049 and U.S. Pat. No. 8,210,618, the entire contents of each of these patents being incorporated herein by reference. Such conical or radial tool picks have an axially rearward shank portion and an axially forward head portion with a shoulder and a cutting tip. The one or more support structures 60 can be suitable sized to receive the tool, for example by shaping the support structure 60 like a cradle to support the tool along its axial length both at the shank and at the head portion. The one or more support structures are integrated with base structure of the container and are generally formed of the same material as forms the base structure and is coextruded therewith. Properly sized and located, the one or more support structures secure the tool in a stationary position in the container. FIG. 4 shows an example of a tool 100 supported in a container 10 by the integrated support structures 60.

The container 10 can include a handle 70 protruding from the second surface 36 of the lid 30. Generally, the handle 70 is formed of the same material as forms the lid 30 and is coextruded therewith. The container 10 can also include a recess 80 in an exterior surface of the bottom 22. The recess 80 is oriented and sized to receive the handle 70 of a second container 10 when multiple containers 10 are stacked one on top of the other. When the recess 80 accepts the handle 70, the lid 30 of a lower container in the stack contacts the bottom 22 of the next higher container in the stack in plane contact. The arrangement of features in the interior volume 26 of the container 10 are arranged to accommodate this recess 80.

The container 10 includes a visibility enhancing feature incorporated into one or more of the lid and the base structure. In one exemplary embodiment, the visibility enhancing feature is based on luminescence, is based on reflectance or is based on a combination of luminescence and reflectance.

In exemplary embodiments where the visibility enhancing feature is based on luminescence, aspects of the invention relate to the use of novel persistent phosphors (e.g., phosphors and/or phosphor blends) applied, to, on, and/or in container for tools for excavating and cutting geological formations. The components of the container are typically formed of a plastic material, preferably a thermoplastic resin material such as polyethylenes (HDPE, LDPE and LLDPE) and polypropylene (PP), and polyacetylene (PA), in a process such as extrusion or injection molding. The lid or the base structure or both the lid and the base structure or a portion of the lid and/or the base structure is formed with a phosphor material distributed homogenously throughout. The lid and the base can have different or same phosphor materials. Additionally, the lid and the base can use phosphor materials in only a portion of their structure. Thus, for example, (i) the lid can use a phosphor that emits visible light of a first wavelength, such as blue, and the base can be non-emitting, (i) the base can use a phosphor that emits visible light of a first wavelength, such as blue, and the lid can be non-emitting, (iii) the lid can use a phosphor that emits visible light of a first wavelength, such as blue, and the base can use a phosphor that emits visible light of a first wavelength, such as blue, and (iv) the lid can use a phosphor that emits visible light of a first wavelength, such as blue, and the base can use a phosphor that emits visible light of a second wavelength, such as red.

For example, the phosphors may be distributed in the polymeric material by a mechanical mixing process to form the raw material used in further processing. The mixed raw material is then extruded into a forming device which blow molds the final shape of the part. Single stream processing using one raw material with the distributed phosphor, or multi-stream processing, using more than one raw material, more than one of which may or may not have the distributed phosphor or may use different phosphors, may be used to incorporate the phosphor into specific portions or into the entire piece of the lid or base structure of a container for tools for excavating and cutting geological formations. The application of the phosphor provides for easier and faster identification and location of the container and its contents as well as objects in relatively close proximity, i.e., within 3-6 feet, to the container in, for example, low light situations which may be useful in operating conditions encountered in underground mines as well as may be critical in an emergency situation where, for example, power (e.g., lighting) has been lost.

Luminescence is a form of cold body radiation and involves the emission of light by a substance not resulting from heat. Luminescence can be caused by many different phenomena, including chemical reactions, electrical energy, subatomic motions, or stress on a crystal. A phosphor, most generally, is a substance that exhibits the phenomenon of luminescence. This includes both phosphorescent materials, which show a slow decay in brightness (>1 ms), and fluorescent materials, where the emission decay takes place over tens of nanoseconds. Phosphors have three characteristics: (i) the type of energy by which they are energized, (ii) the color of the visible light that they produce, and (iii) the length of time that they glow after being energized (known as the persistence of the phosphor). In exemplary embodiments disclosed herein, the phosphor is energized by light in the visible spectrum, typically having wavelengths from about 390 to 700 nm, and that has a very long persistence, although other phosphors with activation energies outside the visible spectrum can also be used. The light in the visible spectrum used to energize the phosphors can be from any suitable source, including lighting systems of the underground mine, natural sunlight, headlamps from vehicles and flashlights or other portable lighting.

For example, exemplary embodiments of the phosphor for inclusion in the components of the container include dopant activated-zinc sulfide, dopant activated-calcium sulfide, dopant activated-strontium sulfide or dopant activated-strontium aluminate. Calcium sulfide with strontium sulfide with bismuth as activator, (Ca,Sr)S:Bi, yields blue light with persistence up to 12 hours. The mixture of zinc sulfide and cadmium sulfide emit color depending on the ratio of these components—increasing the CdS content shifts the output color towards longer wavelengths—and has a persistence that ranges between 1-10 hours. Strontium aluminate can be activated by europium, SrAl₂O₄:Eu(II):Dy(III), and produces green and aqua hues, where green gives the highest brightness and aqua the longest persistence. The excitation wavelengths for strontium aluminate range from 200 to 450 nm.

Although a visibility enhancing feature based on luminescence using phosphors is currently the preferred approach, as an alternative to the above phosphor approach, the visibility enhancing feature can use a material based on bioluminescence, chemiluminescence or radioluminescence.

Homogenous distribution of the phosphor in the material forming the lid or base structure allows the visible electromagnetic radiation emitted by the phosphor to be observable from the first surface of the lid and from the second surface of the lid. These two surfaces coincide with the interior surface and exterior surface of the lid as observed when the lid closes the opening in the base structure of the container. Therefore, not just objects exterior to the container (i.e., structures of the underground mine such as support services, emergency equipment or signage) can be illuminated, but also objects contained with the interior volume of the container (i.e., replacement parts, safety equipment, and tools) can be illuminated. This improves both visibility of the container itself but also visibility of the contents.

Further, the spectrum of emitted light can correspond to the particular contents or use of the container. For example, emitted light in a particular color spectrum can designate a specific product line of tools, or a tool for a specific type of excavating equipment or a tool for a specific brand of excavating equipment. As a non-limiting example, light in the blue spectrum can designate a Sandvik carbide tip tool, light in the red spectrum can designate a Sandvik Trispec® carbide tipped tool and light in the yellow spectrum can designate a XT grade carbide tipped tool. Suitable lettering embossed on exterior surfaces of the container can also be used in conjunction with the emitted light in the particular color spectrum to identify the contents or use of the container.

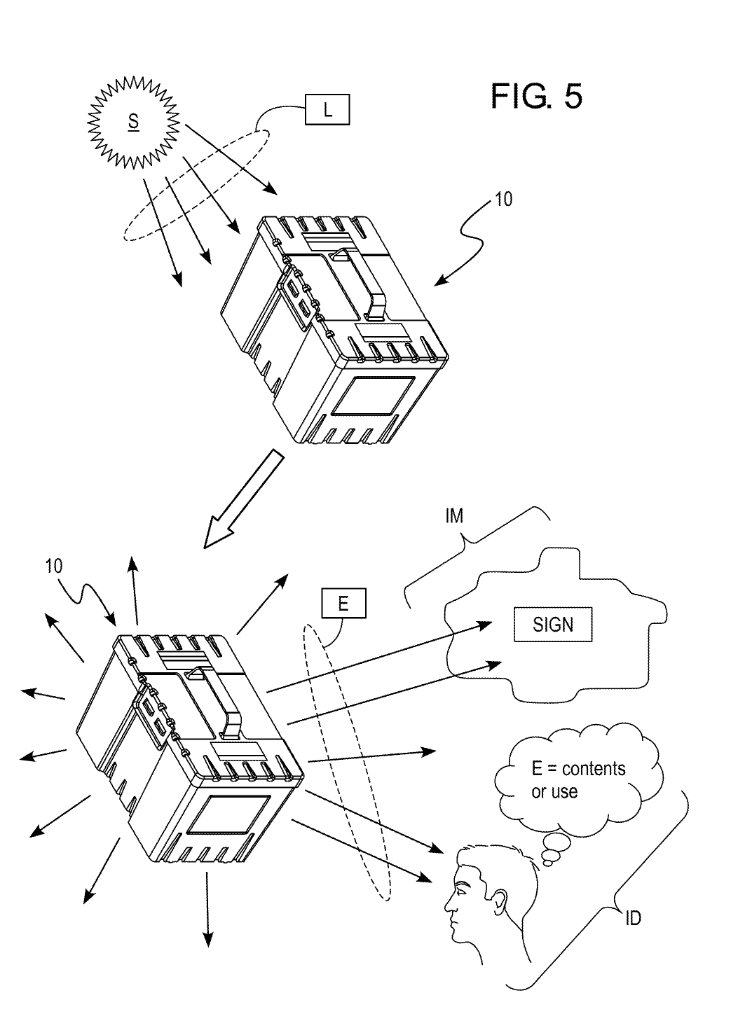

FIG. 5 shows a basic sequence of irradiating a container 10 with light (L) from a source (S), the container 10 (removed from the source (S)) then emitting visible light (E), which then illuminates the mine or a structure or feature in a mine (IM) and/or allows correlation to a particular contents or use of the container (ID). An example of a structure or feature in a mine can include signage, installed structures such as storage areas, ladders, or lockers, and the walls, floor and ceiling of the mine.

In exemplary embodiments where the visibility enhancing feature is based on reflectance, aspects of the invention relate to applying on, adhering to or incorporating onto a surface of the container a reflectance structure. In preferred embodiments, the reflectance structure is a layer of a reflective material. The reflective material can be any suitable material that reflects incident electromagnetic radiation. The reflective material can exhibit specular reflectance, diffuse reflectance or retroreflection. In specular reflection, reflection from a surface is mirror-like, in which light from an incoming direction (a ray) is reflected into an outgoing direction. Diffuse reflection is the reflection of light from a surface such that an incident ray is reflected at many angles. In retroreflection, incident light is reflected back along the same axis, i.e., the incident axis, with a minimum of scattering, preferably less than 5% scattering and alternatively, less than 2% scattering or no scattering. Preferably, the reflective material exhibits retroreflection.

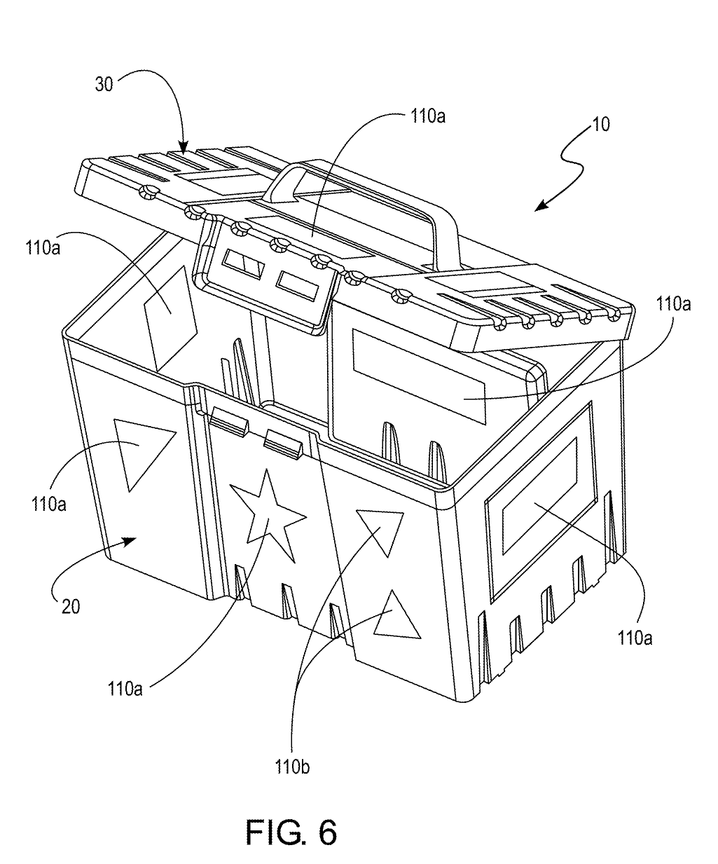

The reflectance structure can be in the form of a coating or a layer on a surface of the container. FIG. 6 shows an exemplary embodiment of a container 10. Variously, exterior and/or interior surfaces of the base structure 20 and the lid 30 can have a reflectance structure 110 in the form of a coating or a layer as described herein. The reflectance structure 110 can be a single feature 110a per a surface or can be multiple discreet features 110b on a surface.

Examples of suitable reflective materials for the reflectance structure include barium sulfate coatings or paints and retroflective tapes, transfer films, sheeting and inks (such as reflective material available from 3M™ under the Scotchlite™ brand and which are reflective material with an adhesive backing). In this embodiment, the components of the container are typically formed of a plastic material, preferably a thermoplastic material such as polyethylenes (HDPE, LDPE and LLDPE) and polypropylene (PP), and polyacetylene (PA), in a process such as extrusion or injection molding. The layer of a reflectance material is applied on, adhered to or incorporated onto a surface of the lid or the base structure or both the lid and the base structure or a portion of the lid and/or the base structure.

Similar to the embodiment based on luminescence, the embodiment based on reflectance can use the spectrum of light reflected by the reflectance structure to correspond to the particular contents or use of the container. For example, reflected light in a particular color spectrum can designate a specific product line of tools, or a tool for a specific type of excavating equipment or a tool for a specific brand of excavating equipment. As a non-limiting example, light in the blue spectrum can designate a Sandvik carbide tip tool, light in the red spectrum can designate a Sandvik Trispec® carbide tipped tool and light in the yellow spectrum can designate a XT grade carbide tipped tool. Additionally or alternatively, a particular shape of a reflectance structure, such as a geometric shape or a sequence of shapes, can correspond to the particular contents or use of the container. Suitable lettering embossed on exterior surfaces of the container can also be used in conjunction with the reflected light in the particular color spectrum to identify the contents or use of the container. It should be noted that the light incident on the reflectance structure can be from any suitable source, including lighting systems of the underground mine, natural sunlight, headlamps from vehicles and flashlights or other portable lighting. Further, a sequence similar to that shown in FIG. 5 applies to containers with a reflectance structure, except that instead of emitting visible light, the container reflects the light from the source, and the reflected light then illuminates the mine or the structure or feature in the mine and/or allows correlation to the particular contents or use of the container.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A container for tools for excavating and cutting geological formations, the container comprising:
a base structure including a bottom and one or more side walls joined to define an interior volume accessible via an opening;
a lid connected to the base structure to close the opening, the lid including a first surface and a second surface, wherein when the lid closes the opening, the first surface faces the interior volume and the second surface forms a part of an exterior of the container; and
a visibility enhancing feature incorporated into one or more of the lid and the base structure, the visibility enhancing feature based on luminescence or reflectance.

2. The container of claim 1, wherein the visibility enhancing feature is based on luminescence from a first thermoplastic composition comprising at least one thermoplastic resin and a first phosphor, and
wherein one or more of the lid and a portion of the base structure are formed from the first thermoplastic composition.

3. The container of claim 2, wherein visible electromagnetic radiation emitted by the first phosphor of the first thermoplastic composition forming the lid is observable from the first surface of the lid and from the second surface of the lid.

4. The container of claim 3, wherein the portion of the base structure is formed from a second thermoplastic composition comprising at least one thermoplastic resin and a second phosphor, and visible electromagnetic radiation emitted by the second phosphor of the first thermoplastic composition forming the at least a portion of the base structure is observable from surfaces of the interior volume of the base structure and from exterior surfaces of the base structure.

5. The container of claim 4, wherein all of the base structure is formed from the second thermoplastic composition.

6. The container of claim 4, wherein the first phosphor and the second phosphor are the same.

7. The container of claim 2, wherein the first phosphor is dopant activated-zinc sulfide, dopant activated-calcium sulfide, dopant activated-strontium sulfide or dopant activated-strontium aluminate or mixtures thereof.

8. The container of claim 2, wherein the first phosphor is homogenously distributed in the first thermoplastic composition.

9. The container of claim 1, wherein the visibility enhancing feature is based on reflectance from a first reflectance structure located on a surface of one or more of the lid and a portion of the base structure.

10. The container of claim 9, wherein the reflectance is retroreflectance.

11. The container of claim 9, wherein visible electromagnetic radiation emitted by the first phosphor of the first thermoplastic composition forming the lid is observable from the first surface of the lid and from the second surface of the lid.

12. The container of claim 1, including a latch for securing the lid in a closed position, wherein the latch is integrally formed with the lid and snaps onto a receiving protrusion on one of the side walls.

13. The container of claim 1, including a handle protruding from the second surface of the lid.

14. The container of claim 13, including a recess in an exterior surface of the bottom, the recess oriented and sized to receive the handle of a second container when the container is stacked on top of the second container.

15. The container of claim 1, wherein the bottom and one or more side walls form five sides of a box.

16. The container of claim 1, wherein the container includes one or more support structures for the tool, the one or more support structures within the interior volume of the container.

17. The container of claim 11, wherein the one or more support structures are formed integrated with base structure of the container.

18. A kit comprising:
the container of claim 1; and
a tool for excavating and cutting geological formations,
wherein the tool is a cutting pick and includes an axially rearward shank portion and an axially forward head portion, the head portion further including a shoulder portion and a cutting tip.

19. The kit of claim 18, wherein the container includes one or more support structures for the tool, the one or more support structures within the interior volume of the container.

20. The kit of claim 19, wherein the one or more support structures are size and arranged to secure the tool in a stationary position in the container.

21. The kit of claim 19, wherein the one or more support structures are formed integrated with base structure of the container.

22. A container for tools for excavating and cutting geological formations, the container comprising:
a base structure including a bottom and one or more side walls joined to define an interior volume accessible via an opening; and
a lid connected to the base structure to close the opening, the lid including a first surface facing the interior volume and a second surface opposing the first surface and forming a part of an exterior of the container,
wherein the base structure is formed of a first thermoplastic composition comprising at least one thermoplastic resin and a first phosphor, the first phosphor homogenously distributed in the first thermoplastic composition,
wherein the lid is formed from a second thermoplastic composition comprising at least one thermoplastic resin and a second phosphor, the second phosphor homogenously distributed in the second thermoplastic composition,
wherein visible electromagnetic radiation emitted by the first phosphor of the first thermoplastic composition is observable from interior surfaces of the base structure and from exterior surfaces of the base structure, and
wherein visible electromagnetic radiation emitted by the second phosphor of the second thermoplastic composition is observable from the first surface of the lid and from the second surface of the lid.

23. A method of illuminating a portion of an underground mine, the method comprising:
irradiating the container of claim 2 with electromagnetic radiation or particle radiation; and
placing the container in a location in an underground mine,
wherein the visible electromagnetic radiation emitted by the phosphor of the thermoplastic composition illuminates a structure of the underground mine.

24. A method of identifying a tool located in an underground mine, the method comprising:
irradiating the container of claim 2 with electromagnetic radiation or particle radiation; and
placing the container in a location in an underground mine,
wherein a color of the visible electromagnetic radiation emitted by the phosphor of the thermoplastic composition is an indicia of the tool stored in the container.
